(19) United States
(12) Patent Application Publication
(10) Pub. No.: US 2026/0234430 A1
(43) Pub. Date: Aug. 13, 2026

(54) HYDROPHILIC COPOLYMER AND COATING COMPOSITION COMPRISING THE SAME AND ANTIFOG USE THEREOF

(71) Applicant: MOMENTIVE PERFORMANCE MATERIALS INC., Niskayuna, NY (US)

(72) Inventors: Jianpeng LI, Shanghai (CN); Fred WANG, Shanghai (CN); Johannes G. P. DELIS, Bergen Op Zoom (NL); Kaijun XU, Shanghai (CN)

(21) Appl. No.: 19/156,640

(22) PCT Filed: Feb. 17, 2023
(86) PCT No.: PCT/CN2023/076810

§ 371 Date: Aug. 14, 2025

(51) Int. Cl. C09D 133/26; C08F 8/42; C08K 5/42; C09D 7/45; C09D 7/63; C09D 133/14

(52) U.S. Cl. CPC C09D 133/26; C08F 8/42; C09D 7/45; C09D 7/63; C09D 133/14; C08F 2800/10; C08F 2810/20; C08K 5/42

(57) ABSTRACT

The present invention relates to a hydrophilic copolymer and a coating composition comprising the same and anti-fog use thereof. The hydrophilic copolymer comprises repeating units derived from a siloxy-functionalized monomer and from a hydrophilic organic monomer. The hydrophilic copolymer and the coating composition can be used to impart anti-fog and scratch resistant properties. The present invention also relates to an article comprising a coating film formed from the coating composition.

### FIELD OF THE INVENTION

The present invention relates to a hydrophilic copolymer and a coating composition comprising the copolymer. In particular, the hydrophilic copolymer comprises repeating units derived from a siloxy-functionalized monomer and a hydrophilic organic monomer. The copolymer and the coating composition imparts anti-fog and/or scratch resistance to a plastic substrate or article. The present invention also relates to an article comprising a coating film formed from the coating composition.

### BACKGROUND OF THE INVENTION

Transparent plastic substrates, such as those made from polycarbonate and poly (meth)acrylate, are widely used in automotive and architecture applications, for example, as safety glass, protective shields and the like. Such transparent substrates may suffer from fogging and become hazy due to condensation of droplets on surfaces thereof, when the surface temperature of the substrates is below the dew point of ambient moisture.

A conventional solution for solving the fogging problem is to coat a hydrophilic coating film on the surface of the transparent substrates. A common hydrophilic coating liquid used for anti-fog purposes is based on a low molecular dispersant or surfactant having a hydrophilic group. The hydrophilic coating film formed from such a coating liquid is generally poor in scratch resistance. In order to improve scratch resistance, polymer-based coating films formed from crosslinking reactions, for example, using polyisocyanate as the crosslinking agent to react with the hydroxyl groups in the polymer, are of interest. Due to the resultant crosslinked system, the scratch resistance is improved to some degree, but it remains insufficient for practical use. Crosslinking reactions of epoxy groups can also improve scratch resistance. However, the epoxy groups tend to cause yellowing, thereby degrading transparency and durability of the coating film.

In addition, due to the presence of the hydrophilic groups in the coating film, moisture from the ambient environment can be absorbed into the hydrophilic coating, degrading performance of the coating film over time. Also, adhesion of the coating film to the substrate may also be adversely affected.

Therefore, there remains a need to provide an anti-fog coating film which has a scratch resistance sufficient for practical use, strong adhesion to the substrates, and performance which does not deteriorate with time.

### SUMMARY OF THE INVENTION

In an aspect, the present invention relates to a hydrophilic copolymer comprising: a first repeating unit represented by general formula (1):

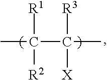

and
a second repeating unit represented by general formula (2):

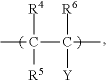

and optionally,
a third repeating unit represented by general formula (3):

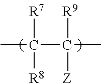

wherein
R¹, R², R³, R₄, R⁵, R⁶, R⁷, R⁸ and R⁹ are each independently selected from a hydrogen atom, or a monovalent hydrocarbon group having 1 to about 16 carbon atoms and optionally containing a heteroatom;
X is a monovalent siloxy-containing group represented by -(L^{F})ₘ-L¹-Si(OR¹¹)ₐ(R¹²)₃₋ₐ,
Y is a monovalent hydrophilic group represented by -(L^{F})ₘ-(L²)ₙ-C(O)—N(R²¹)(R²²), and
Z is a monovalent organic group represented by -(L^{F})ₘ-(L³)ₙ-C(O)-L⁴-R³¹, where
each occurrence of L^{F} independently represents a divalent organic group selected from —O—, —N(R)—, —C(O)—, —OC(O)—, —C(O)O—, —N(R)C(O)—, —C(O)N(R)—, —N(R)C(O)O— or —OC(O)N(R)—, where R represents a hydrogen atom, or an alkyl group having 1 to about 6 carbon atoms;
each occurrence of L¹, L² and L³ independently represents a substituted or un-substituted divalent hydrocarbon group having 1 to about 20 carbon atoms and optionally containing a heteroatom;
L⁴ is selected from an oxygen atom or a sulfur atom;
R¹¹ is each independently an alkyl group having 1 to about 12 carbon atoms;
R¹² is each independently a monovalent hydrocarbon group having 1 to about 16 carbon atoms and optionally containing a heteroatom;
R²¹ and R²² are each independently selected from a hydrogen atom, or a monovalent hydrocarbon group having 1 to about 16 carbon atoms and optionally containing a heteroatom;
R³¹ is selected from a hydrogen atom, or a monovalent hydrocarbon group having 1 to about 16 carbon atoms which optionally contains one or more functional groups selected from a hydroxyl, a mercapto, an ether, an ester, an amine, or a carboxyl group;
each occurrence of subscripts m and n is independently 0 or 1; and subscript a is 1, 2 or 3.

In another aspect, the present invention relates to a method for preparing the hydrophilic copolymer in accordance with the above aspect, wherein a first monomer of the formula C(R¹)(R²)═C(R³)X, a second monomer of the formula C(R⁴)(R⁵)═C(R⁶) Y and optionally a third monomer of the formula C(R⁷)(R⁸)═C(R⁹) Z, with each of R¹, R², R³, R₄, R⁵, R⁶, R⁷, R⁸, R⁹, X, Y and Z being defined as above, are subject to radical polymerization in the presence of an initiator.

In another aspect, the present invention relates to a coating composition comprising the hydrophilic copolymer in accordance with the above aspect. In an embodiment, the coating composition is a curable coating composition.

In another aspect, the present invention relates to a two- or multi-packaging coating system comprising at least a first packaging composition and a second packaging composition, and optionally a third packaging composition, wherein the first packaging composition comprises the hydrophilic copolymer in accordance with the above aspect; and the second packaging composition comprises a catalyst.

In another further aspect, the present invention relates to a method for preparing a coating composition, comprising blending the hydrophilic copolymer in accordance with the above aspect with a catalyst and optionally a component selected from a surfactant, a solvent, a crosslinking agent, an adhesion promoter or any combination of two or more thereof.

In another further aspect, the present invention relates to a cured composition formed from the curable coating composition in accordance with the above aspect. In some embodiments, the cured composition is formed in the absence of a crosslinking agent.

In yet another aspect, the present invention relates to an article comprising a substrate, wherein at least a portion of a surface of the substrate comprises a coating film formed from the coating composition in accordance with the above aspect. In some embodiments, the article is selected from safety glass, a protective shield, an automobile headlight, a windshield, eyeglasses, goggles, a mirror, a transparent container, a window, or a camera lens.

In still another aspect, the present invention relates to a method for imparting anti-fog and/or scratch resistant properties to a substrate or an article, comprising applying the hydrophilic copolymer, the coating composition, the two- or multi-packaging coating system or the cured composition in accordance with any of the above aspects to the substrate or the article.

In accordance with the present invention, the coating composition comprising the hydrophilic copolymer herein can form a coating film which is transparent, exhibits excellent anti-fog property, has strong adhesion to transparent substrates, such as polycarbonate and poly (meth)acrylate, and provides good scratch resistance sufficient for practical use. In some preferable embodiments, the coating film in accordance with the present invention shows an excellent durability in that the anti-fog and the adhesion performance can be maintained even after immersing in water at 40° C. for 1 hour and then drying at 80° C. for 30 minutes.

### DESCRIPTION OF THE INVENTION

In the specification and claims herein, the following terms and expressions are to be understood as indicated.

The singular forms “a”, “an”, and “the” include the plural, and reference to a particular numerical value includes at least that particular value, unless the context clearly dictates otherwise.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

The terms, “comprising”, “including”, “containing”, and grammatical equivalents thereof are inclusive or open-ended terms that do not exclude additional, unrecited elements or method steps, but will also be understood to include the more restrictive terms “consisting of” and “consisting essentially of”.

Other than in the working examples or where otherwise indicated, all numbers expressing amounts of materials, temperatures, time durations, quantified properties of materials, and so forth, stated in the specification and claims are to be understood as being modified in all instances by the term “about” whether or not the term “about” is used in the expression.

It will be understood that any numerical range recited herein includes all sub-ranges within that range and any combination of the various endpoints of such ranges or sub-ranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

Throughout the disclosure, the term “hydrocarbon group” means any hydrocarbon, either saturated or unsaturated, aliphatic or aromatic, acyclic or cyclic, from which one or more hydrogen atoms has been removed; and represents any of alkyl, alkenyl, alkynyl, cyclic alkyl, cyclic alkenyl, cyclic alkynyl, aryl, aralkyl and alkaryl groups which may optionally contain one or more heteroatoms. In one embodiment, the hydrocarbon group may contain up to about 20 carbon atoms and in another embodiment up to about 16 carbon atoms.

The term “alkyl” means any monovalent, saturated straight, branched or cyclic hydrocarbon group. Examples of alkyls include methyl, ethyl, propyl, butyl and cyclohexyl. The term “alkenyl” means any monovalent straight, branched, or cyclic hydrocarbon group containing one or more carbon-carbon double bonds where the site of attachment of the group can be either at a carbon-carbon double bond or elsewhere therein. Examples of alkenyls include vinyl, propenyl, allyl, methallyl and cyclohexylvinyl. The term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkynyls include acetylenyl, propargyl and methylacetylenyl.

The term “aryl” as used herein means any monovalent aromatic hydrocarbon group having about 6 to about 30 carbon atoms, preferably about 6 to about 20 carbon atoms, and more preferably about 6 to about 18 carbon atoms. Examples of aryls include phenyl and naphthyl. The term “aralkyl” means any alkyl group (as defined herein) in which one or more hydrogen atoms have been substituted by the same number of like and/or different aryl (as defined herein) groups. Examples of aralkyls include benzyl and phenethyl. The term “alkaryl” means any aryl group (as defined herein) in which one or more hydrogen atoms have been substituted by the same number of like and/or different alkyl groups (as defined herein). Examples of alkaryls include tolyl and xylyl.

The term “heteroatom” means any of the Group 13-17 elements except carbon and includes, for example, oxygen, nitrogen, silicon, sulfur, phosphorus, fluorine, chlorine, bromine and iodine. In some embodiments, the heteroatom is a halogen atom selected from fluorine, chlorine, bromine and iodine. In some embodiments, the heteroatom is oxygen, nitrogen, or sulfur.

Useful monovalent hydrocarbon groups include: linear or branched alkyl groups such as methyl, ethyl, n-propyl, isopropyl, n-butyl, isobutyl, tert-butyl, n-pentyl, isopentyl, neopentyl, tert-pentyl, hexyl such as n-hexyl, heptyl such as n-heptyl, octyl such as n-octyl, isooctyl and 2,2,4-trimethylpentyl, nonyl such as n-nonyl, decyl such as n-decyl, and cycloalkyl such as cyclopentyl, cyclohexyl, cycloheptyl and methylcyclohexyl; alkenyl groups, for example, linear or branched alkenyl such as vinyl, propenyl, allyl and methallyl, and cyclic alkenyl such as cyclohexenyl; alkynyl groups such as acetylenyl, propargyl and methylacetylenyl; aryl groups such as phenyl, naphthyl; alkaryl groups such as o-, m- and p-tolyl, xylyl; and aralkyl groups such as phenethyl and benzyl.

Useful divalent hydrocarbon groups include alkylene, alkenylene, alkynylene, arylene, or any combination of two or more thereof, which may optionally contain one or more heteroatoms, for example oxygen, nitrogen, sulfur atom or halogen atom. In some embodiment, the divalent hydrocarbon groups may optionally contain one or more functional groups including, for example, a hydroxyl, a mercapto, an ether, an ester, an amine, an amide, or a carboxyl group. The divalent hydrocarbon group may contain 1 to about 20 carbon atoms, for example 1 to about 16 carbon atoms, preferably 1 to about 12 carbon atoms, and more preferably about 3 to about 10 carbon atoms.

A “hydrophilic” substance (e.g., hydrophilic group, hydrophilic monomer, hydrophilic (co) polymer, etc.) refers to one which has an affinity for water or is capable of absorbing water. A hydrophilic substance may be soluble or insoluble in water. In some embodiments, a hydrophilic substance can comprise hydrophilic and hydrophobic potions, but the hydrophobic portions are present in relative amounts such that the substance is hydrophilic as a whole.

In an aspect, the present invention provides a hydrophilic copolymer comprising repeating unit derived from a siloxy-functionalized monomer and from a hydrophilic organic monomer. Due to the repeating units functionalized with the siloxy group, the hydrophilic copolymer may be crosslinked even without a crosslinking agent to provide a cured product having a high crosslink density. The repeating units derived from the hydrophilic monomer may provide the copolymer with a sufficient hydrophilic property to exhibit anti-fog performance. The hydrophilic copolymer may further comprise repeating units derived from an additional organic monomer, which may tune the properties, such as the hydrophilic property, of the copolymer.

Preferably, the hydrophilic copolymer herein comprises:
a first repeating unit represented by general formula (1):

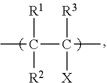

and
a second repeating unit represented by general formula (2):

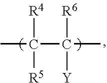

and optionally,
a third repeating unit represented by general formula (3):

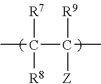

wherein
R¹, R², R³, R₄, R⁵, R⁶, R⁷, R⁸ and R⁹ are each independently selected from a hydrogen atom, or a monovalent hydrocarbon group having 1 to about 16 carbon atoms, preferably 1 to about 12 carbon atoms, more preferably 1 to about 8 carbon atoms, or 1 to about 6 carbon atoms. The hydrocarbon group herein may optionally contains a heteroatom, for example, a halogen atom, or oxygen, nitrogen, or sulfur atom.

X in formula (1) is a monovalent siloxy-containing group represented by -(L^{F})ₘ-L¹-Si(OR¹¹)ₐ(R¹²)₃₋ₐ, where L^{F} represents a divalent organic group selected from —O—, —N(R)—, —C(O)—, —OC(O)—, —C(O)O—, —N(R)C(O)—, —C(O)N(R)—, —N(R)C(O)O— or —OC(O)N(R)— where R represents a hydrogen atom, or an alkyl group having 1 to about 6 carbon atoms, preferably 1 to about 4 carbon atoms, for example, methyl, ethyl, n-propyl, isopropyl, n-butyl, isobutyl, tert-butyl; and in one embodiment, L^{F} is selected from —OC(O)—, —C(O)O—, —N(R)C(O)—, —C(O)N(R)—, —N(R)C(O)O—, or —OC(O)N(R)—; preferably-C(O)O— or —C(O)N(R)—. L¹ represents a substituted or un-substituted divalent hydrocarbon group having 1 to about 20 carbon atoms, preferably 1 to about 16 carbon atoms, and more preferably 1 to about 10 carbon atoms, such as 1, 2, 3, 4, 5, 6, 7, 8, 9 or 10 carbon atoms. L¹ may optionally contain one or more heteroatoms selected from, for example, oxygen, nitrogen, or sulfur atom. In an embodiment, L¹ may optionally contain one or more functional groups selected from, for example, a hydroxyl, a mercapto, an ether, an ester, an amine, an amide, or a carboxyl group. In an embodiment, L¹ is a linear or branched alkylene group, a cycloalkylene group, an arylene group, or any combination of two or more thereof, which may contain or may be substituted with one or more functional groups selected from, for example, a hydroxyl, a mercapto, an ether, an ester, an amine, an amide, or a carboxyl group. In one embodiment, L¹ is a linear or branched alkylene group having 2 to 8 and preferably 3 to 6 carbon atoms. R¹¹ is each independently an alkyl group having 1 to about 12 carbon atoms, preferably 1 to 8 carbon atoms, and more preferably 1 to 6 carbon atoms, examples of which include methyl, ethyl, n-propyl, and isopropyl. R¹² is each independently a monovalent hydrocarbon group having 1 to about 16 carbon atoms, preferably 1 to about 12 carbon atoms, more preferably 1 to about 8 carbon atoms, or 1 to about 6 carbon atoms. R¹² may optionally be substituted with a heteroatom, for example, a halogen atom such as Cl or Br. The subscript m is 0 or 1; and a is 1, 2, or 3.

In an embodiment, X in formula (1) is-L¹-Si(OR¹¹)ₐ(R¹²)₃₋ₐ or -L^{F}-L¹-Si(OR¹¹)ₐ(R¹²)₃₋ₐ, with each of L^{F}, L¹, R¹¹, R¹² and subscript a being defined as above. In one embodiment, X is-L^{F}-L¹-Si(OR¹¹)ₐ(R¹²)₃₋ₐ where L^{F} is —C(O)O— or —C(O)N(R)—; L¹ is a linear or branched alkylene group having 2 to 8 and preferably 3 to 6 carbon atoms, and optionally containing one or more functional groups selected from, for example, a hydroxyl, a mercapto, an ether, an ester, an amine, an amide, or a carboxyl group; R¹¹ is each independently an alkyl group having 1 to about 8 carbon atoms; R¹² is each independently selected from an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms; and a is 2 or 3.

Y in formula (2) is a monovalent hydrophilic group represented by -(L^{F})ₘ-(L²), —C(O)—N(R²¹)(R²²), where L^{F} represents a divalent organic group selected from —O—, —N(R)—, —C(O)—, —OC(O)—, —C(O)O—, —N(R)C(O)—, —C(O)N(R)—, —N(R)C(O)O— or —OC(O)N(R)— where R represents a hydrogen atom, or an alkyl group having 1 to about 6 carbon atoms, preferably 1 to about 4 carbon atoms, for example, methyl, ethyl, n-propyl, isopropyl, n-butyl, isobutyl, tert-butyl; and in one embodiment, L^{F} is selected from —OC(O)—, —C(O)O—, —N(R)C(O)—, —C(O)N(R)—, —N(R)C(O)O—, or —OC(O)N(R)—; preferably-C(O)O— or —C(O)N(R)—. L² represents a substituted or un-substituted divalent hydrocarbon group having 1 to about 20 carbon atoms, preferably 1 to about 16 carbon atoms, and more preferably 1 to about 10 carbon atoms, such as 1, 2, 3, 4, 5, 6, 7, 8, 9 or 10 carbon atoms. L² may optionally contain one or more heteroatoms selected from, for example, oxygen, nitrogen, or sulfur atom. In an embodiment, L² may optionally contain one or more functional groups selected from, for example, a hydroxyl, a mercapto, an ether, an ester, an amine, an amide, or a carboxyl group. In an embodiment, L² is a linear or branched alkylene group, a cycloalkylene group, an arylene group, or any combination of two or more thereof, which may contain or may be substituted with one or more functional groups selected from, for example, a hydroxyl, a mercapto, an ether, an ester, an amine, an amide, or a carboxyl group. R²¹ and R²² are each independently selected from a hydrogen atom, or a monovalent hydrocarbon group having 1 to about 16 carbon atoms, preferably 1 to about 12 carbon atoms, more preferably 1 to about 8 carbon atoms, or 1 to about 6 carbon atoms. R²¹ and R²² may optionally contain one or more heteroatoms, for example, O, S or N. For example, R²¹ and R²² may each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms. Illustrative examples of R²¹ and R²² include methyl, ethyl, n-propyl, isopropyl, n-butyl, isobutyl, tert-butyl, phenyl, benzyl, ethylphenyl, tolyl or xylyl. The subscripts m and n are independently 0 or 1.

In an embodiment, Y in formula (2) is selected from:

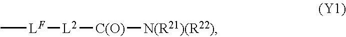

where L^{F} is selected from —OC(O)—, —C(O)O—, —N(R)C(O)—, —C(O)N(R)—, —N(R)C(O)O—, or —OC(O)N(R)—; L² is a divalent hydrocarbon group having 1 to about 20 carbon atoms which optionally contains one or more functional groups selected from a hydroxyl, a mercapto, an ether, an ester, an amine, an amide, or a carboxyl group; R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms;

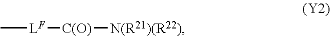

where L^{F} is selected from —O—, —N(R)—, —C(O)—, —OC(O)—, —C(O)O—, —N(R)C(O)—, —C(O)N(R)—, —N(R)C(O)O—, or —OC(O)N(R)—; R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms;

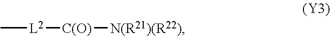

where L² is a divalent hydrocarbon group having 1 to about 20 carbon atoms which optionally contains one or more functional groups selected from a hydroxyl, a mercapto, an ether, an ester, an amine, an amide, or a carboxyl group; R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms; or

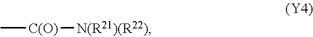

where R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms.

In one embodiment, Y in formula (2) is selected from the above formula (Y1), (Y2), (Y3) or (Y4) where R²¹ and R²² are each independently selected from an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms. The second repeating unit in accordance to this embodiment may contribute to the improved long term anti-fog property of the coating film formed from the hydrophilic copolymer.

Z in formula (3) is a monovalent organic group represented by -(L^{F})ₘ-(L³)ₙ-C(O)-L⁴-R³¹, where L^{F} represents a divalent organic group selected from —O—, —N(R)—, —C(O)—, —OC(O)—, —C(O)O—, —N(R)C(O)—, —C(O)N(R)—, —N(R)C(O)O— or —OC(O)N(R)— where R represents a hydrogen atom, or an alkyl group having 1 to about 6 carbon atoms, preferably 1 to about 4 carbon atoms, for example, methyl, ethyl, n-propyl, isopropyl, n-butyl, isobutyl, tert-butyl; and in one embodiment, L^{F} is selected from —OC(O)—, —C(O)O—, —N(R)C(O)—, —C(O)N(R)—, —N(R)C(O)O—, or —OC(O)N(R)—; preferably-C(O)O— or —C(O)N(R)—. L³ represents a substituted or un-substituted divalent hydrocarbon group having 1 to about 20 carbon atoms, preferably 1 to about 16 carbon atoms, and more preferably 1 to about 10 carbon atoms, such as 1, 2, 3, 4, 5, 6, 7, 8, 9 or 10 carbon atoms. L³ may optionally contain one or more heteroatoms selected from, for example, oxygen, nitrogen, or sulfur atom. In an embodiment, L³ may optionally contain one or more functional groups selected from, for example, a hydroxyl, a mercapto, an ether, an ester, an amine, an amide, or a carboxyl group. In an embodiment, L³ is a linear or branched alkylene group, a cycloalkylene group, an arylene group, or any combination of two or more thereof, which may contain or may be substituted with one or more functional groups selected from, for example, a hydroxyl, a mercapto, an ether, an ester, an amine, an amide, or a carboxyl group. L⁴ is selected from an oxygen atom or a sulfur atom. R³¹ is selected from a hydrogen atom, or a monovalent hydrocarbon group having 1 to about 16 carbon atoms, preferably 1 to about 12 carbon atoms, more preferably 1 to about 8 carbon atoms, or 1 to about 6 carbon atoms. R³¹ may optionally contain one or more functional groups selected from a hydroxyl, a mercapto, an ether, an ester, an amine, or a carboxyl group. The subscripts m and n are independently 0 or 1.

In one embodiment, Z in formula (3) is selected from:
-L^{F}-L³-C(O)—O—R³¹ or -L^{F}-L³-C(O)—S—R³¹, where L^{F} is selected from —OC(O)—, —C(O)O—, —N(R)C(O)—, —C(O)N(R)—, —N(R)C(O)O—, or —OC(O)N(R)—; L³ is a divalent hydrocarbon group having 1 to about 20 carbon atoms which optionally contains one or more functional groups selected from a hydroxyl, a mercapto, an ether, an ester, an amine, an amide, or a carboxyl group; and R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group;
-L^{F}-C(O)—O—R³¹ or -L^{F}-C(O)—S—R³¹, where L^{F} is selected from —O—, —N(R)—, —C(O)—, —OC(O)—, —C(O)O—, —N(R)C(O)—, —C(O)N(R)—, —N(R)C(O)O—, or —OC(O)N(R)—; and R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group;
-L³-C(O)—O—R³¹ or -L³-C(O)—S—R³¹, where L³ is a divalent hydrocarbon group having 1 to about 20 carbon atoms which optionally contains one or more functional groups selected from a hydroxyl, a mercapto, an ether, an ester, an amine, an amide, or a carboxyl group; and R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group; or
—C(O)—O—R³¹ or —C(O)—S—R³¹, where R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group.

The properties of the hydrophilic copolymers and the coating compositions formed by the copolymers may be controlled or tuned by varying the molar ratios of the various repeating units (i.e., the monomers from which the repeating units are derived) in the copolymers. In an embodiment, the first repeating unit represents about 1 mol % to about 40 mol % of the hydrophilic copolymer, preferably about 2 mol % to about 35 mol %, more preferably about 3 mol % to about 30 mol %, for example about 4 mol % to about 25 mol %, or about 5 mol % to about 20 mol %. A higher molar ratio of the first repeating unit is advantageous in view of the long term anti-fog properties of the coating film formed from the hydrophilic copolymer. The second repeating unit represents about 25 mol % to about 85 mol % of the hydrophilic copolymer, preferably about 30 mol % to about 80 mol %, and more preferably about 35 mol % to about 75 mol %, for example about 40 mol % to about 70 mol %, or about 45 mol % to about 65 mol %. The third repeating unit represents about 0 mol % to about 50 mol % of the hydrophilic polymer, preferably about 5 mol % to about 45 mol %, and more preferably about 10 mol % to about 40 mol %, for example about 15 mol % to about 39 mol %, or about 20 mol % to about 38 mol %. In an embodiment, when the third repeating unit is present, the molar ratio of the second repeating unit to the third repeating unit may vary from about 1:1 to about 5:1, preferably about 1.1:1 to about 4:1, and more preferably about 1.2:1 to about 3:1.

The molecular weight of the hydrophilic copolymers may be varied depending on the polymerization conditions including, for example, the monomers used to form the copolymers and their relative amounts, and polymerization temperature and time period, and the like. In an embodiment, the hydrophilic copolymers herein may have a weight average molecular weight (Mw) of about 50,000 to 50,0000, preferably about 60,000 to 40,0000, and more preferably 70,000 to 30,0000; and a number average molecular weight (Mn) of about 5,000 to 12,0000, preferably about 6,000 to 9,0000, and more preferably 7,000 to 60,0000, as measured by gel permeation chromatography (GPC) using polystyrene standards.

In an embodiment, the hydrophilic copolymer is a copolymer of the first and the second repeating units. In a preferable embodiment, the hydrophilic copolymer is a terpolymer of the first, the second, and the third repeating units.

The hydrophilic copolymer herein may be prepared by radical polymerization, for example radical addition-polymerization of the monomers corresponding to each of the repeating units. The monomers may include a first monomer which is a siloxy-functionalized monomer of the formula C(R¹)(R²)═C(R³)X, a second monomer which is a hydrophilic organic monomer of the formula C(R⁴)(R⁵)═C(R⁶) Y and optionally a third monomer which is an additional organic monomer of the formula C(R⁷)(R⁸)═C(R⁹) Z, wherein each of R¹, R², R³, R₄, R⁵, R⁶, R⁷, R⁸, R⁹, X, Y and Z are the same as defined regarding formula (1), (2) and (3) above. The radical polymerization is well known in the art, and the specific condition for carrying out radical polymerization can be selected depending on the monomers used to form the hydrophilic copolymer. For example, the radical polymerization may be carried out in a temperature ranging from about 40° C. to about 100° C. for a time period of about 1 to about 10 hours. The radical polymerization can be carried out in the presence of an initiator. The initiator can be, for example, a thermal initiator or a photo-initiator.

Illustrative examples of suitable thermal initiators include, but are not limited to, an azo initiator, an inorganic peroxide initiator, or an organic peroxide initiator, for example, an azo initiator selected from 2,2′-azobis-(2-methylpropionitrile), 2,2′-azobis-(2-methylbutanenitrile), or 2,2′-azobis-(2,4-dimethylvaleronitrile); an inorganic peroxide initiator selected from ammonium persulfate, sodium persulfate, or potassium persulfate; and an organic peroxide initiator selected from benzoyl peroxide or dilauroyl peroxide. In an embodiment, the thermal initiator is 2,2′-azobis-(2-methylpropionitrile) (AIBN) or 2,2′-azobis-(2,4-dimethylvaleronitrile) (ABVN).

Illustrative examples of suitable photo-initiators include, but are not limited to, benzoin methyl ether, diethoxyacetophenone, 2-hydroxy-2-methyl propiophenone (HMPP), 1-hydroxycyclohexyl phenyl ketone, and benzoylphosphine oxide such as 2,4,6-trimethylbenzoyldiphenylophosphine oxide.

The radical polymerization may be carried out in a solvent. Illustrative examples of the solvent include, but are not limited to, hydrocarbon solvent, alcoholic solvent, ether solvent, amide solvent, ester solvent, and halohydrocarbon solvent. Examples of the hydrocarbon solvent include n-hexane, n-pentane, benzene, toluene, and xylene. Examples of the alcoholic solvent include C1-C5 alcohols such as methanol, ethanol, propanol, isopropanol (IPA), n-butanolt-butanol, methoxy propanol and methoxy butanol. Examples of the ether solvent include diethyl ether, diisopropyl ether, methyl t-butyl ether, tetrahydrofuran (THF), cyclopentyl methyl ether, dimethoxyethane, and 1,4-dioxane. Examples of the amide solvent include dimethylformamide (DMF), dimethylacetamide (DMAc), and N-methyl-2-pyrrolidone (NMP). Examples of the ester solvent include C1-C4 alkyl acetate esters such as ethyl acetate. Examples of the halohydrocarbon solvent include chloroform, methylene chloride, and 1, 2-dichloroethane. These solvents may be used alone or in combination of two or more thereof. In some embodiments, the amide solvent such as dimethylformamide (DMF) and dimethylacetamide (DMAc) are used for preparing the hydrophilic copolymer herein.

In another aspect, the present invention provides a coating composition comprising the hydrophilic copolymer in accordance with the above aspect. The hydrophilic copolymer may be present in an amount ranging from about 30 wt % to about 99.9 wt %, preferably about 35 wt % to about 99 wt %, more preferably about 40 wt % to about 98 wt %, even more preferably about 45 wt % to about 97 wt %, based on the total solid content of the composition.

The composition may further comprise a component selected from a catalyst, a surfactant, a solvent, a crosslinking agent, or any combination of two or more thereof.

Illustrative examples of the catalyst that may be used in the coating composition herein include, but are not limited to, tetraalkylammonium carboxylates of the formula [(R⁴¹)₄N]⁺[OC(O)R⁴²]⁻ in which R⁴¹ is selected from an alkyl group having 1 to about 6 carbon atoms, and R⁴² is selected from a hydrogen atom, an alkyl group having 1 to about 10 carbon atoms, an aryl group having about 6 to about 16 carbon atoms, an aralkyl having about 7 to about 16 carbon atoms, or an alkaryl having about 7 to about 16 carbon atoms. In some embodiments, R⁴¹ is an alkyl having 1 to about 4 carbon atoms, such as methyl, ethyl, propyl, isopropyl, n-butyl or isobutyl. In some embodiments, R⁴² is methyl, ethyl, propyl, isopropyl, n-butyl, isobutyl, 2-ethylhexyl, phenyl or benzyl. For example, the tetraalkylammonium carboxylate catalysts include, but are not limited to, tetrabutylammonium carboxylate such as tetrabutylammonium formate, tetra-n-butylammonium acetate (TBAA), tetra-n-butylammonium propionate, tetra-n-butylammonium-2-ethylhexanoate, and tetra-n-butylammonium benzoate; and tetramethylammonium acetate, tetramethylammonium-2-ethylhexanoate, tetramethylammonium benzoate, tetraethylammonium acetate, tetraisopropylammonium acetate, and tetrahexylammonium acetate. Among these catalysts, tetrabutylammonium caboxylate catalysts are generally preferred, with tetra-n-butylammonium acetate and tetra-n-butylammonium formate being more preferred.

The catalyst may be present in the coating composition in at least a catalytically effective amount which in most cases can range from about 0.1 wt % to about 5 wt %, preferably from about 0.2 wt % to about 4.5 wt %, and more preferably from about 0.5 wt % to about 4 wt %, based on the solid content of the hydrophilic copolymer.

The surfactant may comprise a non-ionic surfactant, an ionic surfactant such as an anionic surfactant, or a combination thereof.

Illustrative examples of suitable non-ionic surfactants include, but are not limited to, polyhydroxyl alcohol fatty acid esters, alcohol ethoxylates, polyoxyethylene lauryl ethers, polyoxyethylene monostearates, polyoxyethylene sorbitan monopalmitate, polyoxyethylene sorbitan monostearate, polyoxyethylene sorbitan monooleate, ethoxylated castor oils such as polyethylene glycol castor oil, and the like. In an embodiment, the non-ionic surfactant is selected from polyhydroxyl alcohol fatty acid esters, for example, esters formed from polyhydroxyl alcohols having about 2 to 20 hydroxyl groups such as sugars, ethylene glycol, glycerol, pentaerythritol, sorbitol and the like with fatty acids having about 1 to about 30 carbon atoms. In a preferable embodiment, the non-ionic surfactant is selected from sugar fatty acid esters, such as monoester, diester or triester of sucrose or glucose with a higher fatty acid such as lauric acid, stearic acid, oleic acid and palmitic acid, or with a lower fatty acid such as acetic acid and isobutyric acid. In one embodiment, a non-ionic surfactant is used which comprises sucrose fatty acid ester selected from sucrose monolaurate, sucrose dilaurate, sucrose monostearate, or sucrose distearate.

Illustrative examples of suitable anionic surfactants include, but are not limited to, alkali metal sulfonates, sulfates, phosphates and carboxylic acid salts surfactants. Specific examples of these surfactants include alkali metal sulfonates such as sulfosuccinates, sulfonated glyceryl esters of fatty acids, salts of sulfonated monovalent alcohol esters, and sulfonated aromatic hydrocarbon alkali metal salts such as sodium dodecyl benzene sulfonate and sodium alpha-naphthalene monosulfonate; sulfates such as sodium lauryl sulfate, sodium cetostearyl sulfate, triethanol amine lauryl sulfate and sodium lauryl ether sulfate; phosphates such as the potassium salts of cetyl phosphate; and carboxylic acid salts such as alkali metal salts of carboxylic acids having about 6 to 30 carbon atoms. In an embodiment, the anionic surfactant is selected from sulfosuccinates, such as alkali metal (such as sodium or potassium) sulfonates of succinic acid monoesters or diesters, preferably sulfonates of monoesters or diesters of succinic acid with fatty alcohol having about 3 to 30 carbon atoms, preferably about 4 to 25 carbon atoms, and more preferably about 6 to 20 carbon atoms. Illustrative examples of sulfosuccinate surfactants include, but are not limited to, sodium sulfonates of succinic acid monoesters such as disodium lauryl sulfosuccinates, and sodium sulfonates of succinic acid diesters such as sodium dioctyl sulfosuccinates. In an embodiment, an anionic surfactant which comprises sulfosuccinate surfactants, for example, sodium dioctyl sulfosuccinates is used.

The surfactant may be present in the coating composition of the present invention in an amount ranging from about 1 wt % to about 25 wt %, preferably from about 3 wt % to about 20 wt %, and more preferably from about 5 wt % to about 15 wt %, based on the solid content of the hydrophilic copolymer.

The coating compositions may include one or more solvents for dissolving or dispersing the various components. Illustrative examples of the solvent include, but are not limited to, hydrocarbon solvent, alcoholic solvent, ether solvent, amide solvent, ester solvent, and halohydrocarbon solvent. Examples of the hydrocarbon solvent include n-hexane, n-pentane, benzene, toluene, and xylene. Examples of the alcoholic solvent include C1-C4 alcohols such as methanol, ethanol, propanol, isopropanol (IPA), n-butanol, and t-butanol. Examples of the ether solvent include diethyl ether, diisopropyl ether, methyl t-butyl ether, tetrahydrofuran (THF), cyclopentyl methyl ether, dimethoxyethane, and 1,4-dioxane. Examples of the amide solvent include dimethylformamide (DMF), dimethylacetamide (DMAc), and N-methyl-2-pyrrolidone (NMP). Examples of the ester solvent include C1-C4 alkyl acetate esters such as ethyl acetate.

Examples of the halohydrocarbon solvent include chloroform, methylene chloride, and 1, 2-dichloroethane. These solvents may be used alone or in combination of two or more thereof. In some embodiments, C1-C5 alcohol solvents such as methanol, ethanol, propanol, isopropanol (IPA), n-butanol, t-butanol, methoxy propanol and methoxy butanol are used for the coating compositions, especially the curable coating compositions.

The solvent may be present in the coating composition of the present invention in an amount sufficient for dispersing the various components, which amount may typically ranges from about 10 wt % to about 95 wt %, preferably from about 15 wt % to about 80 wt %, and more preferably from about 20 wt % to about 75 wt % based on the total weight of the coating composition.

A crosslinking agent may optionally be used. The crosslinking agent, if used, is preferably selected from alkoxylsilane compounds. The alkoxylsilane compounds may be any of trialkylmonoalkoxylsilanes, dialkyldialkoxysilanes, alkyltrialkoxysilanes and tetraalkoxysilanes (also known as tetraalkyl orthosilicates), with alkyltrialkoxysilanes and tetraalkoxysilanes being preferred. Examples of trialkylmonoalkoxysilanes include trimethylmethoxysilane, trimethylethoxysilane, triethylethoxysilane, triethylmethoxysilane, and their mixtures. Examples of dialkyldialkoxysilanes include dimethyldimethoxysilane, diethyldiethoxysilane, diethyldimethoxysilane, and their mixtures. Examples of alkyltrialkoxysilanes include methyltrimethoxysilane, methyltriethoxysilane, ethyltrimethoxysilane, ethyltriethoxysilane, n-propyltrimethoxysilane, n-propyltriethoxysilane, n-butyltrimethoxysilane, isobutyltrimethoxysilane, and mixtures thereof. Examples of tetraalkoxysilanes (i.e., tetraalkyl orthosilicates) include tetramethoxysilane, dimethoxydiethoxysilane, tetraethoxysilane, methoxytriethoxysilane, tetrapropoxysilane, and their mixtures.

The crosslinking agent may be present in an amount of at most about 10 wt %, preferably not more than about 5 wt %, and more preferably not more than about 1 wt %, based on the solid content of the hydrophilic copolymer.

In an embodiment, the curable coating composition of the present invention can be cured to form a cured composition in the absence of any crosslinking agent. A crosslinking agent is generally required in most of conventional curable coating compositions to cause curing of the coating. However, such a crosslinking agent as the alkoxysilane compounds may be subject to self-hydrolysis or condensation, resulting in undesirable by-reactions and by-products. Therefore, it is advantageous to avoid use of such a crosslinking agent.

The coating composition may further comprise, depending on the intended purpose of the composition, optional additives such as an adhesion promoter and a leveling agent known for such use in the coating field. The adhesion promoter may be generally selected by those skilled in the art depending on the substrates to be coated. For example, when the substrates to be coated are polymer substrates, the adhesion promoter may be (meth)acrylate polymers functionalized with hydroxyl, carboxyl or acid anhydride groups, such as (meth)acrylate polyol copolymers; and when the substrates to be coated are glass substrates, the adhesion promoter may be alkoxylsilane functionalized with amino, vinyl or thiol groups. Illustrative examples of the additives commercially available include, but are not limited to, Joncryl® 587 from BASF as the adhesion promoter for polymer substrates, Silquest™ A1110 silane and Silquest™ A1100 silane from Momentive Performance Materials, Inc. as the adhesion promoter for glass substrates, and CoatOSil® coatings additive from Momentive Performance Materials, Inc. as the leveling agent.

In an embodiment, the coating composition may be present in a form of a two- or multi-packaging coating system comprising at least a first packaging composition and a second packaging composition, wherein the first packaging composition comprises the hydrophilic copolymer; and the second packaging composition comprises the catalyst. The multi-packaging coating system may further include a third packaging composition comprising one or more additional components selected from the surfactant, the solvent, the crosslinking agent, the adhesion promoter or any additive conventionally used in a coating composition such as the levelling agent. The additional components may also be present in the first packaging composition and/or the second packing composition, provided that they do no not react with the component(s) already present in the packing composition. In an embodiment, the coating composition is present in a form of a two-packaging coating system comprising the first packaging composition containing the hydrophilic copolymer and the crosslinking agent; and the second packaging composition containing the catalyst, with the remaining components being present in the first packing composition, or the second packing composition, or both. In one embodiment, the coating composition is present in a form of a two-packaging coating system comprising the first packaging composition containing the hydrophilic copolymer, the crosslinking agent and the solvent; and the second packaging composition containing the catalyst, the surfactant, the adhesion promoter, and the solvent which may optionally be different from the solvent in the first packaging composition.

In another embodiment, the coating composition is present in a form of a two-packaging coating system comprising the first packaging composition containing the hydrophilic copolymer, the crosslinking agent, the adhesion promoter and the solvent; and the second packaging composition containing the catalyst, the surfactant, and the solvent which may optionally be different from the solvent in the first packaging composition. In a further embodiment, the coating composition is present in a form of a two-packaging coating system comprising the first packaging composition containing the hydrophilic copolymer, the crosslinking agent, the adhesion promoter, the surfactant and the solvent; and the second packaging composition containing the catalyst and the solvent which may optionally be different from the solvent in the first packaging composition. The coating composition is preferably present in the form of the two- or multi-packaging coating system in terms of storage stability. Each of the components may be present in the two- or multi-packaging coating system in an amount similar to those discussed above regarding the coating composition.

The coating composition herein may be prepared by simply blending the hydrophilic copolymer with the various components in desired proportions. The components may be dispersed or dissolved in a solvent before blending, or may be mixed together directly in the solvent. The curing composition may be optionally diluted to a solid content suitable for the coating method to be adopted to apply the coating composition to a substrate.

In a further aspect, the present invention provides an article comprising a substrate, wherein at least a portion of a surface of the substrate comprises a coating film formed from the coating composition in accordance with the above aspect.

Illustrative examples of suitable substrates include, but are not limited to, polymeric ones, for example, (meth)acrylic polymer such poly(methylmethacrylate), polycarbonate, polyester such as polyethylene terephthalate and polybutylene terephthalate, polyamide, polyimide, acrylonitrile-styrene copolymer, styrene-acrylonitrile-butadiene terpolymer, polyvinyl chloride, polyethylene, or any combination of two or more thereof, and any other suitable substrate such as glass.

The composition may be applied to the substrate by conventional techniques such as brushing coating, spraying coating, dip coating, roller coating or flow coating. The applying or coating amount may be such that the coating film has a dry film thickness in a range of about 0.5 μm to about 30 μm, preferably about 1 μm to about 25 μm, more preferably about 2 μm to about 20 μm, even more preferably about 3 μm to about 15 μm, for example, about 4 μm to about 12 μm or about 5 μm to about 10 μm.

The coating composition may be thermally or UV cured following application of the composition to the substrate. In an embodiment, the wet coating film of the coating composition on the substrate may be optionally flashed off before thermally cured in air or in an inert atmosphere by exposure to an elevated temperature of, for example, about 40° C. to about 200° C., preferably about 50° C. to about 180° C. and more preferably about 60° C. to about 150° C. In another embodiment, the wet coating film of the coating composition on the substrate may be cured by exposure to a suitable radiation such as ultraviolet radiation. The curing time may vary from, for example, about 0.5 hours to about 4 hours, preferably about 1 hour to about 3 hours, depending on the composition of the wet coating film.

The coating film formed from the coating composition herein can substantially limit or prevent fogging of the substrates. In an embodiment, the coating film has strong adhesion to the substrate and exhibit good scratch resistance. In one preferable embodiment, the coating film can maintain the anti-fog and scratch resistance performances for a long period. As such, the substrates with such an anti-fog coating film may be used in a variety of applications including, but not limited to, a safety glass, a protective shield, an automobile headlight, a windshield, eyeglasses, goggles, a mirror, a transparent container, a window, or a camera lens.

In still another aspect, the present invention provides use of the hydrophilic copolymer, the coating composition, or the cured composition in accordance with any of the above aspects for imparting anti-fog and scratch resistant properties to a substrate or an article. The substrates herein include, but are not limited to, polymeric ones, for example, (meth)acrylic polymer such poly(methylmethacrylate), polycarbonate, polyester such as polyethylene terephthalate and polybutylene terephthalate, polyamide, polyimide, acrylonitrile-styrene copolymer, styrene-acrylonitrile-butadiene terpolymer, polyvinyl chloride, polyethylene, or any combination of two or more thereof, and any other suitable substrate such as glass. The articles herein include, but are not limited to, a safety glass, a protective shield, an automobile headlight, a windshield, eyeglasses, goggles, a mirror, a transparent container, a window, or a camera lens. In a preferable embodiment, the anti-fog performance of the substrate or the article can be maintained even after immersing in water at 40° C. for 1 hour and then drying at 80° C. for 30 minutes.

### EXAMPLES

The present invention will be more specifically explained with reference to Examples, but these Examples shall not be construed as to limit the scope of the present invention. In the descriptions below, “part(s)” and “%” denotes “part(s) by weight” and “% by weight”, unless otherwise stated.

### Materials

All of the alkoxylsilane compounds are obtained from Momentive Performance Materials, Inc. OT-70 (sodium dioctyl sulfosuccinate) is obtained from Solvay. L-1695 (sucrose monolaurate) is obtained from Mitsubishi Chemical. Joncryl 587 is an adhesion promoter from BASF.

### General Procedures for Preparation of Hydrophilic Copolymer

All of the reactants were dried to a moisture level of less than 200 ppm before use. A 250-mL four-necked flask was dried and equipped with a mechanical stirrer, a condenser, a nitrogen gas conduct, and a dropping funnel, and then was charged with 40 parts of dimethyl acetamide (DMAc) as the solvent at room temperature. Separately, a mixed solution was prepared by dissolving the reactants and 0.4 parts of 2,2′-azobis-(2,4-dimethylvaleronitrile) (ABVN) as the initiator in 40 parts of DMAc. The flask was gradually heated to 65° C. under N₂ atmosphere and was added with the mixed solution through the dropping funnel over 3 hours. The resultant mixture was allowed to react for another 5 hours at 65° C., and then cooled to room temperature. Finally, a copolymer dispersion was obtained.

### General Procedures for Preparation of Coating Film on Polycarbonate Substrate

The copolymer dispersion as prepared was mixed with methyltrimethoxysilane (MTMS) as the crosslinking agent (if any), the catalyst solution (20% tetra-n-butylammonium acetate (TBAA) in isopropanol) and the surfactant solutions (70% OT-70 in isopropanol and 10% L-1695 in propylene glycol monomethyl ether) in isopropanol (IPA) as the solvent to obtain a coating liquid having a solid content of 15 wt %.

A polycarbonate substrate (PC grade: 2467) was wiped with isopropanol and dried with deionization wind. Then, the coating liquid prepared above was applied to a surface of the dried polycarbonate substrate by flow coating, and flashed off at room temperature for 5 minutes. The polycarbonate substrate was then allowed to cure in an oven at 120° C. for 2 hours and subsequently cool to room temperature.

### Evaluation of Properties

Subsequently, the coated polycarbonate substrate was tested for the initial properties and properties after water immersion procedure. The water immersion procedure included immersing the coated polycarbonate substrate in water at 40° C. for 1 hour, then drying at 80° C. for 30 minutes, and subsequently cooling to room temperature.

The tested properties included appearance of the coating film observed by naked eyes, the thickness of the dried coating film, the adhesion of the coating film to the substrate, and the anti-fog properties. The coating film was also tested for the scratch resistance. More details of each of the tests were given below. The thickness was reported as a range because the coating film was varied in thickness from top to bottom.

### Appearance

The coating film was checked visually by naked eyes. If the dried film is transparent and no peeling occurs, then an “OK” result was given.

### Adhesion Test

The adhesion test was carried out according to ASTM D3359 Method B. A lattice pattern having 25 squares of 2 mm*2 mm is made with six cuts using a knife in each direction in the coating film. An adhesive tape (3M 810) of approximately 4-inch is applied over the lattice pattern, and within 90±30 s of application, the tape is removed from the coating film at an angle as close to 180° as possible. Then, the lattice pattern is examined visually for any peeled off squares. The rating was given from 5B to 0B, with 5B indicating the highest adhesion where none of the squares is affected by the test. The sample is rated 4B if less than 5% of the total area inside the squares is affected by the peel test. 3B, 2B and 1B represent 5-15%, 15-35% and 35-65% peeled, respectively. More than 65% peeled is rated as 0B.

### Anti-Fog Test

The anti-fog test included anti-fog test 1 (AF-1) and anti-fog test 2 (AF-2) which were carried out as follows.

For AF-1, a coated sample was kept 5 cm above the water surface of a water bath in a container held in a heating jacket maintained at 60° C. The sample covered the opening of the container, with the coated surface of the sample facing down to allowed the coated surface to be exposed to the steam from the water bath for 90 seconds. The water layer formed on the sample (if any) was observed visually, and the time at which a fog appeared was recorded as the result of AF-1.

For AF-2, a coated sample was kept 4 cm above the opening of a container accommodating a water bath maintained at 60° C. The water surface was 10 cm below the opening of the container. Thus, the coated surface of the sample faced down to the water surface with the distance between the coated surface and the water surface being 14 cm in total. The coated surface was exposed to the steam from the water bath for 90 seconds. The time at which a fog appeared was recorded as the result of AF-2.

### Scratch Resistance Test

The test was carried out by scratching the coating film using steel wool (0000 #) at 14 Kpa for 11 cycles. The haze values before and after the scratching were measured and the increase of the haze value was reported as the result of scratch resistance.

### Examples 1 to 9

Hydrophilic copolymers were prepared using the reactants as shown in Table 1 below. Each of the prepared copolymer dispersions was mixed with the catalyst solution, the surfactant solution, the solvent, the crosslinking agent of MTMS and the adhesion promoter in amounts as shown in Table 1 to obtain coating compositions. Each of the coating compositions was applied to the polycarbonate substrate and tested for the initial properties and properties after water immersion using the procedures described above. The results were shown in Table 1 below.

The results in Table 1 show that all of the coating films in accordance with the present invention exhibit an anti-fog performance and a strong adhesion to the substrate initially, and a long-term anti-fog performance can be obtained by adjusting the composition of the copolymer.

### Examples 10 to 17

Hydrophilic copolymers were prepared using the reactants as shown in Table 2 below. Each of the prepared copolymer dispersions was mixed with the catalyst solution, the solvent, and the surfactant solution in amounts as shown in Table 2 to obtain coating compositions. No crosslinking agent was used. Each of the coating compositions was applied to the polycarbonate substrate and tested for the initial properties and properties after water immersion using the procedures described above. The results were shown in Table 2 below.

It can be seen from Table 2 that an anti-fog coating film was formed with good scratch resistance and adhesion in the absence of the crosslinking agent.

TABLE 1

| | | | | | | | | |
|---|---|---|---|---|---|---|---|---|
| Ex. 1 | Ex. 2 | Ex. 3 | Ex. 4 | Ex. 5 | Ex. 6 | Ex. 7 | Ex. 8 | Ex. 9 |

Composition of Hydrophilic Copolymer

| | | | |
|---|---|---|---|
| γ-methacryloxy propyl | 15 | 15 | 5 |
| trimethoxysilane | | | |
| methyl methacrylate | 10 | 35 | 25 |
| N,N-dimethyl acrylamide | 20 | 0 | 20 |
| Molecular weight (Mn) | 9856 | 19614 | 27980 |
| Molecular weight (Mw) | 100963 | 53680 | 136437 |
| % Solids | 38.8% | 41.6% | 39% |

Formulation of Coating Composition

| | | | | | | | | | |
|---|---|---|---|---|---|---|---|---|---|
| copolymer dispersion | 12.22 | 12.22 | 12.22 | 12.22 | 12.22 | 12.22 | 12.22 | 12.02 | 12.82 |
| MTMS | 0.25 | 0.15 | 0.05 | 0 | 0.05 | 0.05 | 0.05 | 0.25 | 0.25 |
| 20% TBAA solution | 0.3 | 0.3 | 0.3 | 0.3 | 0.2 | 0.4 | 0.5 | 0.3 | 0.3 |
| 70% OT-70 solution | 0.75 | 0.75 | 0.75 | 0.75 | 0.75 | 0.75 | 0.75 | 0.5 | 0.5 |
| 10% L-1695 solution | 2.55 | 2.55 | 2.55 | 2.55 | 2.55 | 2.55 | 2.55 | 2.55 | 2.55 |
| Joncryl 587(10% in PGM) | 0 | 0 | 0 | 0 | 0 | 0 | 0 | 2.5 | 2.5 |
| IPA | 22.8 | 22.2 | 21.7 | 21.4 | 21.6 | 21.7 | 21.7 | 22.96 | 22.16 |
| Total weight | 38.9 | 38.2 | 37.5 | 37.2 | 37.4 | 37.7 | 37.8 | 41.08 | 41.08 |

Properties

| | | | | | | | | | | |
|---|---|---|---|---|---|---|---|---|---|---|
| Initial | Appearance | OK | OK | OK | OK | OK | OK | OK | Edge | OK |
| Properties | | | | | | | | | slight | |
| | | | | | | | | | white | |
| | Thickness | 3.3-10.2 | 3.4-10.5 | 3.5-9.7 | 3.3-10.2 | 3.5-9.4 | 3.3-10.2 | 3.3-9.7 | 3.7-10.3 | 3.7-8.6 |
| | Adhesion | 5B | 5B | 5B | 5B | 5B | 5B | 5B | 5B | 5B |
| | AF-1 | No fog | No fog | No fog | No fog | No fog | No fog | No fog | No fog | No fog |
| | AF-2 | >90 s | >90 s | >90 s | >90 s | >90 s | >90 s | >90 s | >90 s | >90 s |
| Water | Appearance | OK | OK | OK | OK | OK | OK | OK | Lots of | white |
| Immersion | | | | | | | | | peeled | |
| | Adhesion | 5B | 5B | 5B | 5B | 5B | 5B | 5B | 0B | 5B |
| | AF-1 | 6-17 s | >90 s | >90 s | >90 s | >90 s | >90 s | >90 s | 4 s | 7-19 s |
| | | flash fog | | | | | | | | water layer |
| | | | | | | | | | | distortion, |
| | | | | | | | | | | no fog |
| | AF-2 | >90 s | >90 s | >90 s | >90 s | >90 s | >90 s | >90 s | >12 s | >90 s |

| | | | | | | | | | |
|---|---|---|---|---|---|---|---|---|---|
| Scratch Resistance | 11.34 | 12.05 | 11 | 11.78 | 16.06 | 10.28 | 9.43 | 12.23 | 27.72 |

TABLE 2

| | | | | | | | |
|---|---|---|---|---|---|---|---|
| Ex. 10 | Ex. 11 | Ex. 12 | Ex. 13 | Ex. 14 | Ex. 15 | Ex. 16 | Ex. 17 |

Composition of Hydrophilic Copolymer

| | | | | | | | | |
|---|---|---|---|---|---|---|---|---|
| γ-methacryloxy propyl trimethoxysilane | 15 | | | | 15 | 15 | 15 | 15 |
| γ-methacryloxy propyl triethoxysilane | | 15 | | | | | | |
| γ-methacryloxy propyl dimethoxysilane | | | 15 | | | | | |
| γ-methacryloxy propyl diethoxysilane | | | | 15 | | | | |
| methyl methacrylate | 10 | 10 | 10 | 10 | | | | 10 |
| methyl acrylate | | | | | 10 | | | |
| hydroxylethyl methacrylate | | | | | | 10 | | |
| isobutyl methacrylate | | | | | | | 10 | |
| N,N-dimethyl acrylamide | 20 | 20 | 25 | 25 | 25 | 25 | 25 | |
| N,N-diethyl acrylamide | | | | | | | | 25 |
| % Solids | 38.80% | 40.00% | 39.50% | 40.20% | 38.90% | 39.10% | 39.00% | 39.70% |

Formulation of Coating Composition

| | | | | | | | | |
|---|---|---|---|---|---|---|---|---|
| hydrophilic copolymer dispersion | 12.89 | 12.50 | 12.66 | 12.44 | 12.85 | 12.79 | 12.92 | 12.59 |
| 20% TBAA solution | 0.3 | 0.3 | 0.3 | 0.3 | 0.3 | 0.3 | 0.3 | 0.3 |
| 70% OT-70 solution | 0.75 | 0.5 | 0.5 | 0.75 | 0.75 | 0.75 | 0.75 | 0.75 |
| 10% L-1695 solution | 2.55 | 2.55 | 2.55 | 2.55 | 2.55 | 2.55 | 2.55 | 2.55 |
| IPA | 22.4 | 20.9 | 21.2 | 21.7 | 22.4 | 22.3 | 22.5 | 22.0 |
| Total | 38.9 | 36.8 | 37.2 | 37.8 | 38.8 | 38.7 | 39.0 | 38.2 |

Properties

| | | | | | | | | | |
|---|---|---|---|---|---|---|---|---|---|
| Initial | Appearance | OK | OK | OK | OK | OK | OK | OK | OK |
| Properties | Thickness | 3.3-10.2 | 2.7-6.9 | 2.5-6.1 | 3.3-10.2 | 3.4-10.5 | 3.5-9.7 | 3.3-10.2 | 3.3-10.2 |
| | Adhesion | 5B | 5B | 5B | 5B | 5B | 5B | 5B | 5B |
| | AF-1 | No fog | No fog | No fog | No fog | No fog | No fog | No fog | No fog |
| | AF-2 | >90 s | >90 s | >90 s | >90 s | >90 s | >90 s | >90 s | >90 s |
| Water | Appearance | OK | OK | OK | OK | OK | OK | OK | OK |
| Immersion | Adhesion | 5B | 5B | 5B | 5B | 5B | 5B | 5B | 5B |
| | AF-1 | >90 s | >90 s | >90 s | >90 s | >90 s | >90 s | 3-17 s fog | >90 s |
| | AF-2 | >90 s | >90 s | >90 s | >90 s | >90 s | >90 s | >90 s | >90 s |

| | | | | | | | | |
|---|---|---|---|---|---|---|---|---|
| Scratch Resistance | 11.78 | 16.54 | 17.63 | 23.46 | 12.05 | 14.66 | 11.78 | 16.42 |

### Examples 18 to 22

Hydrophilic copolymers were prepared using the reactants as shown in Table 3 below in accordance with General Procedures for Preparation of Hydrophilic Copolymer. Each of the prepared copolymer dispersions (40% solid) was mixed with 0.4 parts of the catalyst solution, 22.5 parts of the solvent, and the surfactant solution (0.75 parts of OT-70 solution and 2.55 parts of L-1695 solution) to obtain coating compositions.

Each of the coating compositions was applied to a polycarbonate substrate and tested for the initial properties and properties after water immersion using the procedures described above. The results were shown in Table 3 below.

It can be seen from Table 3 that the hydrophilic copolymer formed from an acrylamide compound having a tertiary amino group (such as N, N-dimethyl acrylamide or N, N-diethyl acrylamide) demonstrates a coating film having improved long term anti-fog properties as compared to the corresponding copolymers formed from acrylamide compounds having a primary amino group (such as acrylamide) or having a secondary amino group (such as N-t-butyl acrylamide or N-isopropyl acrylamide).

TABLE 3

| | Ex. 18 | Ex. 19 | Ex. 20 | Ex. 21 | Ex. 22 |
|---|---|---|---|---|---|
| γ-methacryloxy propyl | 15 | 15 | 15 | 15 | 15 |
| trimethoxyl silane | | | | | |
| methyl methacrylate | 10 | 10 | 10 | 10 | 10 |
| acrylamide | 25 | | | | |
| N-t-butyl acrylamide | | 25 | | | |
| N-isopropyl acrylamide | | | 25 | | |
| N,N-dimethyl acrylamide | | | | 25 | |
| N,N-diethyl acrylamide | | | | | 25 |

Properties

| | | | | | | |
|---|---|---|---|---|---|---|
| Initial | Appearance | OK | OK | OK | OK | OK |
| Properties | Thickness | 2-8 | 2-8 | 2-8 | 2-8 | 2-8 |
| | Adhesion | 5B | 5B | 5B | 5B | 5B |
| | AF-1 | No fog | No fog | No fog | No fog | No fog |
| | AF-2 | >90 s | >90 s | >90 s | >90 s | >90 s |
| Properties | Appearance | OK | OK | OK | OK | OK |
| after Water | Adhesion | 5B | 4B | 5B | 5B | 5B |
| Immersion | AF-1 | Fog | Fog | Fog | >90 s | >90 s |
| | | immediately | immediately | immediately | | |
| | AF-2 | Fog | Fog | Fog | >90 s | >90 s |
| | | immediately | immediately | immediately | | |

| | | | | | |
|---|---|---|---|---|---|
| Scratch Resistance | 11.6 | 16.8 | 14.7 | 13.1 | 15.1 |

### Examples 23 to 24

Hydrophilic copolymers were prepared using the reactants as shown in Table 4 below in accordance with General Procedures for Preparation of Hydrophilic Copolymer. Each of the prepared copolymer dispersions was mixed with the catalyst solution, the surfactant solution, the solvent, the crosslinking agent of MTMS and the adhesion promoter (amino propyl trimethoxysilane or amino propyl triethoxysilane) in amounts as shown in Table 4 to obtain coating compositions.

Each of the coating compositions was applied to a glass plate and cured at 125° C. for one hour. The resultant coating films on the glass plate were tested for the initial properties and properties after water immersion using the procedures described above. The results were shown in Table 4 below.

TABLE 4

| | |
|---|---|
| Ex. 23 | Ex. 24 |

Composition of Hydrophilic Copolymer

| | | |
|---|---|---|
| γ-methacryloxy propyl trimethoxysilane | 15 | 15 |
| methyl methacrylate | 15 | 15 |
| N,N-dimethyl acrylamide | 20 | 20 |
| Molecular weight (Mn) | 16425 | 16425 |
| Molecular weight (Mw) | 140047 | 140047 |
| % Solids | 38.8% | 38.8% |

Formulation of Coating Composition

| | | |
|---|---|---|
| copolymer dispersion | 12.22 | 12.22 |
| MTMS | 0.05 | 0.05 |
| 20% TBAA solution | 0.5 | 0.5 |
| 70% OT-70 solution | 0.75 | 0.75 |
| 10% L-1695 solution | 2.55 | 2.55 |
| Aminopropyl trimethoxysilane (A1110 from | 0.0028 | |
| Momentive Performance Materials, Inc.) | | |
| Aminopropyl triethoxysilane (A1100 from | | 0.0028 |
| Momentive Performance Materials, Inc.) | | |
| Isopropanol (IPA) | 21.7 | 21.7 |
| Total weight | 37.8 | 37.8 |

Properties

| | | | |
|---|---|---|---|
| Initial Properties | Appearance | OK | OK |
| | Thickness | 3.3-9.7 | 3.4-10.5 |
| | Adhesion | 5B | 5B |
| | AF-1 | No fog | No fog |
| | AF-2 | >90 s | >90 s |
| Water Immersion | Appearance | OK | OK |
| | Adhesion | 4B | 4B |
| | AF-1 | >90 s | >90 s |
| | AF-2 | >90 s | >90 s |

### Examples 25 and 26

Two samples in a form of two packaging coating system were prepared and stored before use. The polymer dispersion prepared in Example 1, methyltrimethoxysilane (MTMS), tetra-n-butylammonium acetate (TBAA), OT-70 and L-1695 as surfactants, Joncryl 587 as an adhesion promoter, and propylene glycol monomethyl ether (PGME) and isopropanol (IPA) as solvents were stored in two pots (Pot A and Pot B) as shown in Table 5 below. The number in parentheses following each of the components indicated the amount of the corresponding component.

The two pots in each of Examples 25 and 26 were then placed in an oven at 50° C. The appearance of the contents in each of the pots remained unchanged after four weeks. Then, the contents of Pots A and B were mixed together and coated onto a polycarbonate substrate using the above general procedures for preparation of coating film on polycarbonate substrate.

TABLE 5

| | Example 25 | Example 26 |
|---|---|---|
| Pot A | polymer dispersion (25 g) | polymer dispersion (25 g) |
| | MTMS (0.5 g) | MTMS (0.5 g) |
| | IPA (40 g) | Joncryl 587 (0.5 g) |
| | | PGME (4.6 g) |
| | | IPA (40 g) |
| Pot B | TBAA (0.1 g) | TBAA (0.1 g) |
| | OT-70 (1 g) | OT-70 (1 g) |
| | L-1695 (0.5 g) | L-1695 (0.5 g) |
| | Joncryl 587 (0.5 g) | PGME (4.6 g) |
| | PGME (4.6 g) | IPA (5 g) |
| | IPA (5 g) | |

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A hydrophilic copolymer comprising:
a first repeating unit represented by general formula (1): 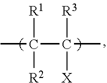
and
a second repeating unit represented by general formula (2): 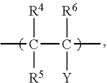
and optionally,
a third repeating unit represented by general formula (3): 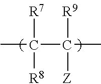
wherein
R¹, R², R³, R₄, R⁵, R⁶, R⁷, R⁸ and R⁹ are each independently selected from a hydrogen atom, or a monovalent hydrocarbon group having 1 to about 16 carbon atoms and optionally containing a heteroatom;
X is a monovalent siloxy-containing group represented by -(L^{F})ₘ-L¹-Si(OR¹¹)ₐ(R¹²)₃₋ₐ,
Y is a monovalent hydrophilic group represented by -(L^{F})ₘ-(L²), —C(O)—N(R²¹)(R²²), and
Z is a monovalent organic group represented by -(L^{F})ₘ-(L³)ₙ-C(O)-L⁴-R³¹,
where
each occurrence of L^{F} independently represents a divalent organic group selected from —O—, —N(R)—, —C(O)—, —OC(O)—, —C(O)O—, —N(R)C(O)—, —C(O)N(R)—, —N(R)C(O)O— or —OC(O)N(R)—, where R represents a hydrogen atom, or an alkyl group having 1 to about 6 carbon atoms;
each occurrence of L¹, L² and L³ independently represents a substituted or un-substituted divalent hydrocarbon group having 1 to about 20 carbon atoms and optionally containing a heteroatom;
L⁴ is selected from an oxygen atom or a sulfur atom;
R¹¹ is each independently an alkyl group having 1 to about 12 carbon atoms;
R¹² is each independently a monovalent hydrocarbon group having 1 to about 16 carbon atoms and optionally containing a heteroatom;
R²¹ and R²² are each independently selected from a hydrogen atom, or a monovalent hydrocarbon group having 1 to about 16 carbon atoms and optionally containing a heteroatom;
R³¹ is selected from a hydrogen atom, or a monovalent hydrocarbon group having 1 to about 16 carbon atoms which optionally contains one or more functional groups selected from a hydroxyl, a mercapto, an ether, an ester, an amine, or a carboxyl group;
each occurrence of subscripts m and n is independently 0 or 1; and
subscript a is 1, 2 or 3.

2. The hydrophilic copolymer of claim 1, wherein each occurrence of L^{F} is independently selected from —OC(O)—, —C(O)O—, —N(R)C(O)—, —C(O)N(R)—, —N(R)C(O)O—, or —OC(O)N(R)—; preferably-C(O)O— or —C(O)N(R)—.

3. The hydrophilic copolymer of claim 1, wherein X is -L¹-Si(OR¹¹)ₐ(R¹²)₃₋ₐ or -L^{F}-L¹-Si(OR¹¹)ₐ(R¹²)₃₋ₐ, preferably -L^{F}-L¹-Si(OR¹¹)ₐ(R¹²)₃₋ₐ, where L^{F} is selected from —OC(O)—, —C(O)O—, —N(R)C(O)—, —C(O)N(R)—, —N(R)C(O)O—, or —OC(O)N(R)—; L¹ is a divalent hydrocarbon group having 1 to about 20 carbon atoms which optionally contains one or more functional groups selected from a hydroxyl, a mercapto, an ether, an ester, an amine, an amide, or a carboxyl group; R¹¹ is each independently an alkyl group having 1 to about 8 carbon atoms; R¹² is each independently selected from an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms; and a is 2 or 3.

4. The hydrophilic copolymer of claim 1, wherein Y is selected from: 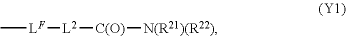
where L^{F} is selected from —OC(O)—, —C(O)O—, —N(R)C(O)—, —C(O)N(R)—, —N(R)C(O)O—, or —OC(O)N(R)—; L² is a divalent hydrocarbon group having 1 to about 20 carbon atoms which optionally contains one or more functional groups selected from a hydroxyl, a mercapto, an ether, an ester, an amine, an amide, or a carboxyl group; R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms; 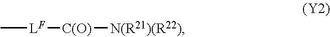
where L^{F} is selected from —O—, —N(R)—, —C(O)—, —OC(O)—, —C(O)O—, —N(R)C(O)—, —C(O)N(R)—, —N(R)C(O)O—, or —OC(O)N(R)—; R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms; 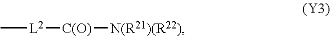
where L² is a divalent hydrocarbon group having 1 to about 20 carbon atoms which optionally contains one or more functional groups selected from a hydroxyl, a mercapto, an ether, an ester, an amine, an amide, or a carboxyl group; R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms; or 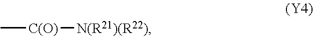
where R²¹ and R²² are each independently selected from a hydrogen atom, an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms;
preferably, Y is selected from the above formula (Y1), (Y2), (Y3) or (Y4) where R²¹ and R²² are each independently selected from an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms.

5. The hydrophilic copolymer of claim 1, wherein the copolymer comprises the third repeating unit with the monovalent organic group Z being selected from:
-L^{F}-L³-C(O)—O—R³¹ or -L^{F}-L³-C(O)—S—R³¹, where L^{F} is selected from —OC(O)—, —C(O)O—, —N(R)C(O)—, —C(O)N(R)—, —N(R)C(O)O—, or —OC(O)N(R)—; L³ is a divalent hydrocarbon group having 1 to about 20 carbon atoms which optionally contains one or more functional groups selected from a hydroxyl, a mercapto, an ether, an ester, an amine, an amide, or a carboxyl group; and R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group;
-L^{F}-C(O)—O—R³¹ or -L^{F}-C(O)—S—R³¹, where L^{F} is selected from —O—, —N(R)—, —C(O)—, —OC(O)—, —C(O)O—, —N(R)C(O)—, —C(O)N(R)—, —N(R)C(O)O—, or —OC(O)N(R)—; and R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group;
-L³-C(O)—O—R³¹ or -L³-C(O)—S—R³¹, where L³ is a divalent hydrocarbon group having 1 to about 20 carbon atoms which optionally contains one or more functional groups selected from a hydroxyl, a mercapto, an ether, an ester, an amine, an amide, or a carboxyl group; and R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group; or
—C(O)—O—R³¹ or —C(O)—S—R³¹, where R³¹ is selected from a hydrogen atom, or an alkyl group having 1 to about 12 carbon atoms, an aryl group having about 6 to about 16 carbon atoms, an aralkyl having about 7 to about 16 carbon atoms, or an alkaryl having about 7 to about 16 carbon atoms which is optionally substituted with one or more functional groups selected from a hydroxyl, a mercapto, an ether, an ester, an amine, or a carboxyl group.

6. The hydrophilic copolymer of claim 1 wherein the first repeating unit represents about 1 mol % to about 40 mol % of the hydrophilic copolymer, preferably about 2 mol % to about 35 mol %, and more preferably about 5 mol % to about 30 mol %; the second repeating unit represents about 25 mol % to about 85 mol % of the hydrophilic copolymer, preferably about 30 mol % to about 80 mol %, and more preferably about 35 mol % to about 75 mol %; and the third repeating unit represents about 0 mol % to about 50 mol % of the hydrophilic copolymer, preferably about 5 mol % to about 45 mol %, and more preferably about 10 mol % to about 40 mol %.

7. The hydrophilic copolymer of claim 1 wherein the copolymer is a copolymer of the first and the second repeating units; or a terpolymer of the first, the second, and the third repeating units.

8. The hydrophilic copolymer of claim 1 wherein the copolymer has a weight average molecular weight (Mw) of about 50,000 to 50,0000, preferably about 60,000 to 40,0000, and more preferably 70,000 to 30,0000; and a number average molecular weight (Mn) of about 5,000 to 12,0000, preferably about 6,000 to 9,0000, and more preferably 7,000 to 60,0000, as measured by gel permeation chromatography (GPC) using polystyrene standards.

9. A method for preparing the hydrophilic copolymer of claim 1 wherein a first monomer of the formula C(R¹)(R²)═C(R³)X, a second monomer of the formula C(R⁴)(R⁵)═C(R⁶) Y and optionally a third monomer of the formula C(R⁷)(R⁸)═C(R⁹) Z, with each of R¹, R², R³, R⁴, R⁵, R⁶, R⁷, R⁸, R⁹, X, Y and Z being defined as in claim 1, are subject to radical polymerization in the presence of an initiator selected from an azo initiator, an inorganic peroxide initiator, or an organic peroxide initiator, preferably an azo initiator, more preferably 2,2′-azobis-(2-methylpropionitrile), 2,2′-azobis-(2-methylbutanenitrile), or 2,2′-azobis-(2,4-dimethylvaleronitrile).

10. A coating composition comprising the hydrophilic copolymer of claim 1.

11. The coating composition of claim 10, wherein the composition further comprises a catalyst, a surfactant, a solvent, a crosslinking agent, an adhesion promoter or any combination of two or more thereof,
preferably, the catalyst comprises a tetraalkylammonium carboxylate compound;
preferably, the surfactant comprises a non-ionic surfactant preferably polyhydroxyl alcohol fatty acid esters, more preferably sugar fatty acid esters; an ionic surfactant preferably sulfosuccinates, more preferably alkali metal sulfonates of succinic acid monoesters or diesters; or a combination thereof; and
preferably, the crosslinking agent is selected from trialkylmonoalkoxylsilanes, dialkyldialkoxysilanes, alkyltrialkoxysilanes and tetraalkoxysilanes.

12. The coating composition of claim 10, wherein the hydrophilic copolymer is present in an amount of from about 30 wt % to about 99.9 wt %, based on the total solid content of the composition.

13. A two- or multi-packaging coating system comprising at least a first packaging composition and a second packaging composition, and optionally a third packaging composition, wherein the first packaging composition comprises the hydrophilic copolymer of claim 1; and the second packaging composition comprises a catalyst.

14. The two- or multi-packaging coating system of claim 13, further comprising a surfactant, a solvent, a crosslinking agent preferably an alkoxylsilane compound, an adhesion promoter or any combination of two or more thereof, any one of which may be present in at least one of the first packaging composition, the second packaging composition, and the third packaging composition when present.

15. A method for preparing a coating composition, comprising blending the hydrophilic copolymer of claim 1 with a catalyst and optionally a component selected from a surfactant, a solvent, a crosslinking agent, an adhesion promoter or any combination of two or more thereof.

16. A cured composition formed by curing the coating composition of claim 10 with or without a crosslinking agent; or by mixing the first packaging composition with the second packaging composition as defined followed by curing.

17. An article comprising a substrate, wherein at least a portion of a surface of the substrate comprises a coating film formed from the coating composition of claim 10.

18. The article of claim 17, wherein the substrate is selected from glass, (meth)acrylic polymer, polycarbonate, polyethylene terephthalate, polybutylene terephthalate, polyamide, polyimide, acrylonitrile-styrene copolymer, styrene-acrylonitrile-butadiene terpolymer, polyvinyl chloride, polyethylene, or a combination thereof.

19. A method for imparting anti-fog and/or scratch resistant properties to a substrate or an article, comprising applying the hydrophilic copolymer of claim 1.

20. The article of claim 17, wherein the article is selected from a safety glass, a protective shield, an automobile headlight, a windshield, eyeglasses, goggles, a mirror, a transparent container, a window, or a camera lens.
